(19) United States
(12) Patent Application Publication
(10) Pub. No.: US 2016/0232638 A1
(43) Pub. Date: Aug. 11, 2016

(54) INTELLIGENT VENUE ENTRANCE GUIDING SYSTEM AND METHOD AND CLIENT WIRELESS DEVICE FOR THE SAME

(71) Applicants: Inventec Appliances (Pudong) Corporation, Shanghai (CN); Inventec Appliances Corp., New Taipei City (TW)

(72) Inventor: Hsin-Yu CHEN, New Taipei City (TW)

(21) Appl. No.: 14/818,317

(22) Filed: Aug. 5, 2015

(30) Foreign Application Priority Data
Feb. 11, 2015 (CN) 201510072335.9

(51) Int. Cl. G06Q 90/00; H04W 4/02

(52) U.S. Cl. CPC G06Q 90/20; H04W 4/021

(57) ABSTRACT

An intelligent venue entrance guiding system provides guidance to locations in a venue divided into at least one area, and includes a client wireless device, at least one wireless access point installed in the area, and multiple location indicator devices installed in the area. The location indicator devices emit a first indication light according to the area. The wireless access point records location numbers associated with the location indicator devices respectively, and is connected to the location indicator devices. The client wireless device stores location information and emits a second indication light according to the location information. When the client device is within a scanning region of the wireless access point and the location information is matched with one of the locations numbers recorded, the client device displays a reminder message and controls the state of the first indication light of the location indicator device associated with the location information.

### RELATED APPLICATIONS

This application claims priority to China Patent Application Serial Number 201510072335.9, filed Feb. 11, 2015, which is herein incorporated by reference.

### BACKGROUND

1. Field of Invention

The present disclosure relates to a system, method, and device for providing guidance. More particularly, the present disclosure relates to an intelligent venue entrance guiding system, method, and device for providing guidance information to locations in a venue.

2. Description of Related Art

With the improvement in living standards, entertainment has become a vital part in our daily life. Great music concerts and athletic events are becoming more and more popular, such that the venues demands for such events are higher so as to provide sufficient capacity to accommodate up to tens of thousands of people.

Although the venue with huge capacity can facilitate the experiences of participating in the events, the audience normally spends a great deal of time and efforts in finding their seats. Even though attendants of the venues provide convenient seat information at the entrances of the venues, it is still very often that the event-goers sit in the wrong seats or have trouble finding their seats, which causes great inconvenience and affects the mood of watching the shows. Moreover, the delay in the entrance of the audience may lead to the events not start as scheduled, and incur unnecessary overtime fines.

### SUMMARY

An aspect of the present disclosure is directed to an intelligent venue entrance guiding system for providing guidance to locations in a venue divided into at least one area. The intelligent venue entrance guiding system includes multiple location indication devices and at least one wireless access point installed in the area, and further includes a client wireless device. The location indication devices are configured for emitting a first indication light according to the area. The wireless access point is configured for recording multiple location numbers respectively associated with the location indication devices, and is coupled to those location indication devices. The client wireless device is configured for storing a location information and emitting a second indication light according to the location information. When the client wireless device is within a scanning region of the wireless access point and the location information is matched with one of the location numbers recorded by the wireless access point, the client wireless device is configured for displaying a reminder message.

Another aspect of the present disclosure is directed to an intelligent venue entrance guiding method for a client wireless device to provide guidance to locations in a venue divided into at least one area and in which multiple location indication devices and a wireless access point are installed. The intelligent venue entrance guiding method includes the following operations: emitting a first indication light with the location indication devices according to the area; emitting a second indication light with the client wireless device according to a location information; and displaying a reminder message when the client wireless device is within a scanning region of the wireless access point in the area and the location information is matched with one of location numbers recorded by the wireless access point. Moreover, the location numbers are respectively associated with the location indication devices installed in the area.

Yet another aspect of the present disclosure is directed to a client wireless device for providing guidance to locations in a venue divided into at least one area in which multiple location indication devices and a wireless access point are installed. The location indication devices are configured for respectively emitting a first indication light. The client wireless device includes a wireless communication unit, a memory unit, a display unit, and a processing unit. The memory unit is configured for storing location information. The display unit is configured for emitting a second indication light according to the location information. The processing unit is configured for inducing a reminder message when the wireless communication is within a scanning region of the wireless access point and the location information is matched with one of location numbers recorded on the wireless access point, and the location numbers are associated with the location indication devices respectively.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a block diagram of an intelligent venue entrance guiding system illustrated according to a first embodiment of the present disclosure;

FIG. 2 is a floor plan sketch of an intelligent venue entrance guiding system illustrated according to another embodiment of the present disclosure;

FIG. 3 is an area floor plan shown on a client wireless device in an intelligent venue entrance guiding system illustrated according to yet another embodiment of the present disclosure; and

FIG. 4 is flow chart of an intelligent venue entrance guiding method illustrated according to a second embodiment of this disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

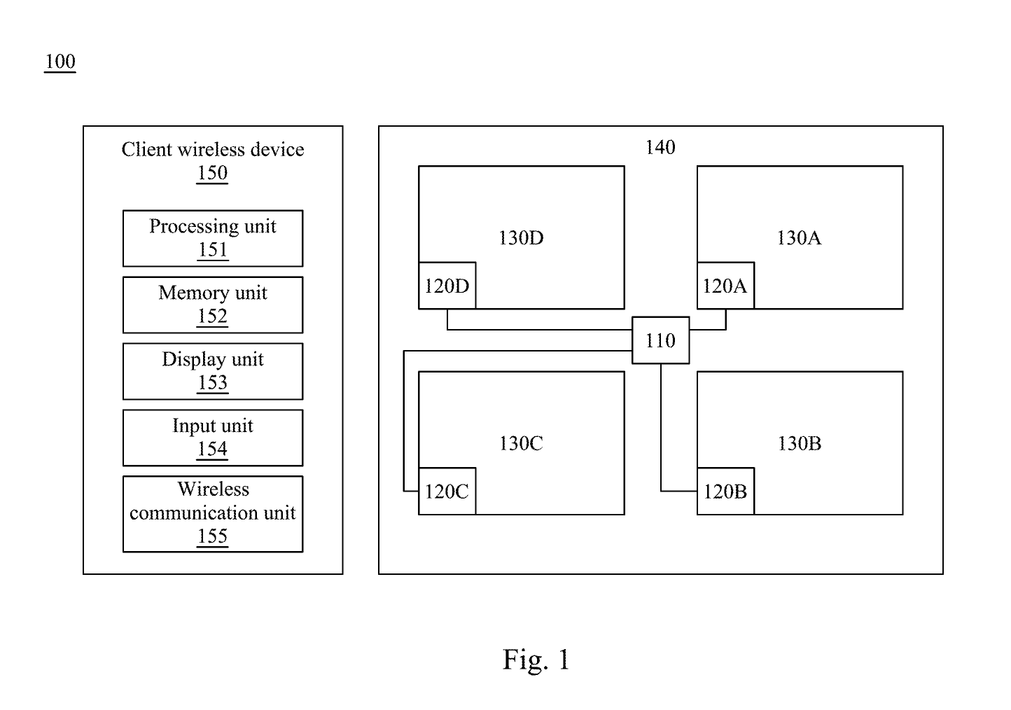

FIG. 1 is a block diagram of an intelligent venue entrance guiding system illustrated according to a first embodiment of the present disclosure. The intelligent venue entrance guiding system 100 is configured for providing guidance information of locations in a venue, and the venue includes at least an area. For clarity and ease of understanding, a case of one single area 140 in the venue is discussed by example to explain the technical details provided in the present disclosure.

As shown in FIG. 1, the venue includes the area 140, and the intelligent venue entrance guiding system 100 includes at least one wireless access point 110 and multiple location indication devices 120 installed in the area 140 and a client wireless device 150. Multiple locations 130 are also set up in the venue. In the present embodiment, the location indication device 120 is used to refer to all location indication devices or a general location indication device, and the location 130 is used to refer to all locations. A prefix of alphabet is used to refer to a particular one of the location devices 120A˜120D and a particular one of the locations 130A˜130D. Numbers of the components illustrated in FIG. 1 are given for reference only, and the disclosure is not limited thereto.

The wireless access point 110 is configured to record location numbers associated with the locations set up in the area 140. In the present embodiment, the location numbers are associated with the locations 130A˜130D and the location indication devices 120A˜120D installed on the locations 130A˜130D. The wireless access point 110 is coupled with the location indication devices 120A˜120D associated with the location numbers recorded in itself, and controls each of the location indication devices 120A˜120D to emit a first indication light according to the area 140 in which the location indication devices 120A˜120D are installed.

In one embodiment, the wireless access point 110 is a WiFi access point. In another embodiment, the wireless access point 110 is a femtocell. In yet another embodiment, the wireless access point 110 is a picocell.

The location indication devices 120 are light emitting devices or display devices. In one embodiment, each of the location devices 120 is one or more light emitting diodes (LED), e.g., an LED array or a seven-segment display. In another embodiment, each of the location devices 120 is an LCD display. In yet another embodiment, each of the location devices 120 is an OLED display.

In one embodiment, the wireless access point 110 is connected with a controller (not shown in the figure) wirelessly, and the controller is coupled with the location indication devices 120A˜120D. The wireless access point 110 controls the location indication devices 120A˜120D via the controller. Those with ordinary skills in the art can think of other ways to couple the wireless access point 110 with the location indication devices 120A˜120D, and the present disclosure is not limited herein.

The client wireless device 150 includes a processing unit 151, a memory unit 152, a display unit 153, an input unit 154, and a wireless communication unit 155. In one embodiment, the client wireless device 150 is a wearable device; the processing unit 151 is a microcontroller; the memory unit 152 is a flash memory; the display unit 153 is an LCD display or a VFD display; the input unit 154 includes buttons or a keyboard; and the wireless communication unit 155 is a mobile network chip, a Bluetooth communication chip, or a WiFi communication chip. In another embodiment, the client wireless device 150 is a tablet or a smartphone; the processing unit 151 is an ARM-based processor or a MIPS-based processor; the memory unit 152 is a flash memory or an SD card; the display unit 153 is a touch panel or an AMOLED display; the input unit 154 includes an optical cursor or a keyboard; and the wireless communication unit 155 is a mobile network chip or a WiFi communication chip.

User of the client wireless device 150 enters a location information with the input unit 154, and the client wireless device 150 stores the location information and emits a second indication light according to the location information. The location indication device 120 installed in the area emits the first indication light according to the area in which they are installed, and the client wireless device 150 emits the second indication light according to the location information, such that the user is able to distinguish the area associated with the location information according to the state of the second indication light. Illustratively, the user approaches the area in which the location indication device 120 emitting the first indication light that matches the second indication light is installed.

For example, the state of the first indication light emitted by the location indication device 120 installed in the area 140 is yellow by default. The user enters the location information shown on a performance ticket, e.g., “Block yellow Seat C” in the client wireless device 150, and the client wireless device 150 sets the state of the second indication light as yellow according to the location information. Therefore, the user approaches the area 140, in which the location indication device 120 is installed and according to which the location indication device 120 emits the first indication light as yellow by default, according to the yellow second indication light emitted by the client wireless device 150. The form of the first indication light and the second indication light can be color, text, or any other forms from which those skilled in the art can choose, and the present disclosure is not limited hereto.

The user approaches the area 140 associated with the location information with the guidance of the first indication light and the second indication light. When the client wireless device 150 is within a scanning region of the wireless access point 110, the client wireless device 150 establishes a connection with the wireless access point 110 for communication and sends the location information to the wireless access point 110. When the location information is matched with any one of the location numbers stored (recorded) in the wireless access point 110, the client wireless device 150 is configured to display a reminder message to remind the user that he/she is near the area 140 associated with the location information, such that the user can conveniently find the exact location associated with the location information in the area 140.

In one embodiment, the reminder message is a change in the state of the second indication light emitted by the client wireless device 150, e.g., changing the state from always on to blinking, changing the state from on to off, or changing the color of the second indication light. Those skilled in the art can change other states as the reminder message, and the present disclosure is not limited hereto. In another embodiment, the client wireless device 150 includes a vibration motor (not shown in the figure), and the client wireless device 150 controls the vibration motor to generate vibration as the reminder message.

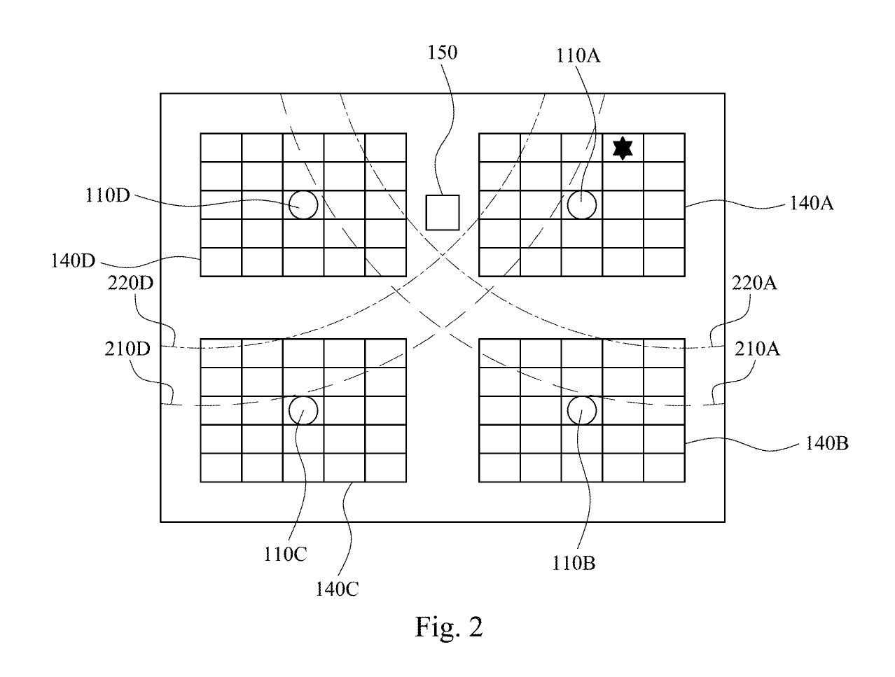

FIG. 2 is a floor plan sketch of the intelligent venue entrance guiding system 100 illustrated according to another embodiment of the present disclosure, so as to illustrate the application scenario with multiple areas. In the present embodiment, the venue is divided into four areas 140A-140D. Those skilled in the art can increase/decrease the number of the areas suitable for their needs, and the present disclosure is not limited hereto.

Wireless access points 110A-110D are installed respectively in the areas 140A-140D in the venue. The wireless access points 110A-110D are configured for recording location numbers associated with location indication device 120 installed in the areas 140A-140D. A user holding or wearing the client wireless device 150 enters an entry of location information into the client wireless device 150. The location information entered is associated with the area 140A and labeled with a star sign. The client wireless device 150 emits a second indication light according to the location information, and the second indication light is matched with the first indication light emitted by the location indication device 120 installed in the area 140A. Therefore, the user approaches the area 140A from the entrance of the venue.

As shown in FIG. 2, the client wireless device 150 is within a scanning region 210A of the wireless access point 110A, and the wireless access point 110A receives the location information sent by the client wireless device 150. The location information is matched with one of the location numbers recorded by the wireless access point 110A, and the client wireless device 150 displays a reminder message. After the user observes the reminder message, the user controls the client wireless device 150 to transmit a control signal to the wireless access point 110A, such that the wireless access point 110A controls the location indication device 120 associated with the location number matched with the location information to change the state of the first indication light according to the control signal. Accordingly, the user identifies the location associated with the location information entered by the user according to the change in the state of the first indication light emitted by the location indication device 120 and finds himself/herself the correct seat.

In one embodiment, the client wireless device 150 is configured to change the state of the first indication light by changing the state from always on to blinking, changing the state from on to off, changing the color of the first indication light emitted according to the area. Those who are skilled in the art can use other changes in state, and the present disclosure is not limited hereto.

It is worth noting that the client wireless device 150 is also within a scanning region 210D of the wireless access point 110D, but the location numbers recorded by the wireless access point 110D are associated with the locations in the area 140D. As a consequence, while the wireless access point 110D also receives the location information from the client wireless device 150, the client wireless device 150 does not display a reminder message after entering the scanning region 210D of the wireless access point 110D because the location information does not match any of the location numbers recorded by the wireless access point 110D. Moreover, the client wireless device 150 is unable to control the location indication devices 120 installed in the area 140D.

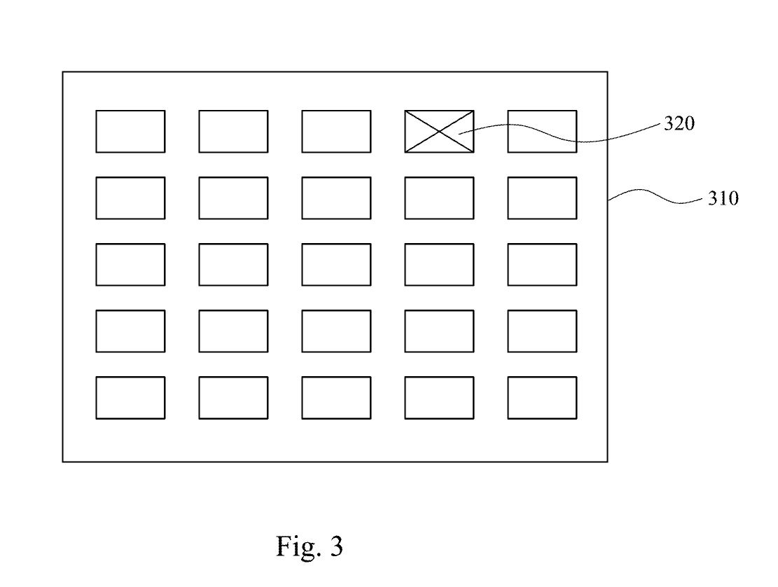

FIG. 3 is an area floor plan shown on the client wireless device 150 in the intelligent venue entrance guiding system 110 illustrated according to yet another embodiment of the present disclosure. After the client wireless device 150 displays the reminder message, an area floor plan 310 of the area associated with the location information entered by the user is displayed on the display unit 153. The location 320 associated with the location number included in the location information is labeled on the area floor plan 310. The user checks the relative location of the location information in the area with the location area plan 310, and controls the location indication device 120 associated with the location information to quickly find the correct location to seat.

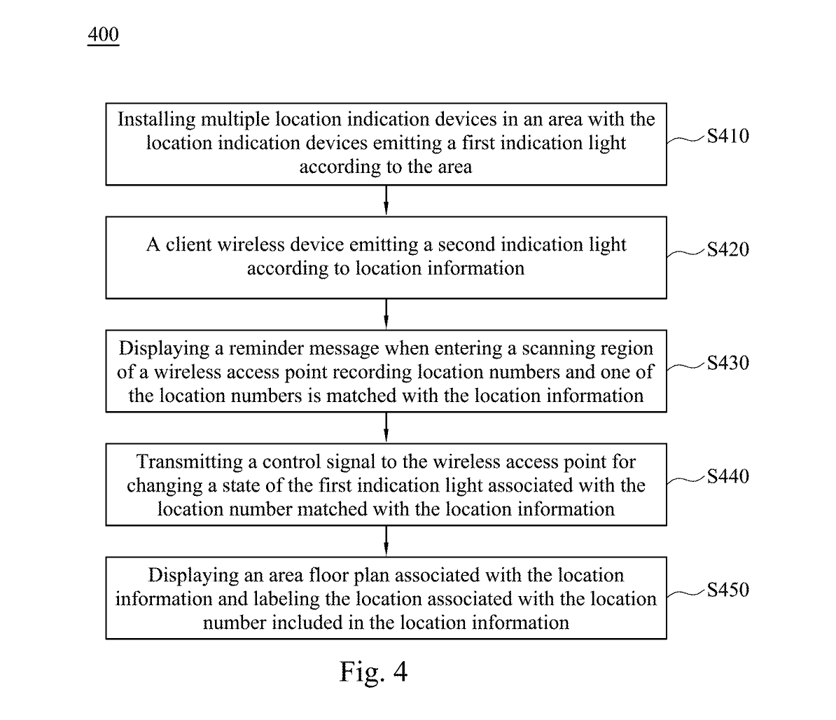

FIG. 4 is a flow chart of an intelligent venue entrance guiding method illustrated according to a second embodiment of this disclosure. The intelligent venue entrance guiding method 400 is used for a client wireless device to provide guidance to locations in a venue including at least one area in which multiple location indication devices and a wireless access point are installed. For clarity and ease of understanding, the descriptions for the intelligent venue entrance guiding method 400 take the intelligent venue entrance guiding system 100 by example, but the present disclosure is not limited hereto. Furthermore, while the process flow described below includes a number of operations that appear to be in a specific order, it should be apparent that these operations may include more or fewer operations, which may be executed serially or in parallel (e.g., using parallel processors or in a multi-threading environment).

A user obtains a client wireless device 150 before entering the venue, and the venue includes at least one area, and multiple location indication devices 120 are installed in the areas respectively, and each of the location indication devices 120 is configured to emit a first indication light according to the area in which each of the location indication devices 120 is installed (operation S410).

The client wireless device 150 is configured to store location information entered by a user, and is configured to emit a second indication light according to the location information (operation S420). In one embodiment, the location information entered by the user is the seat information printed on the ticket including a name for the block and a number for the seat, e.g., “block yellow, row 2, number 13,” and the color of the second indication light emitted by the client wireless device 150 according to the location information is yellow.

In another embodiment, the client wireless device 150 is configured to store a conversion table for converting the state of the second indication light according to the location information entered by the user. For example, the location information entered by the user is “block A, number 33,” the client wireless device 150 determines that “block A” is corresponding to the color red with the conversion table, and changes the color of the second indication light to red according to the location information.

Illustratively, the conversion table is used to record the default states of the first indication light associated with each of the areas, and the client wireless device 150 is configured to set the state of the second indication light according to the area associated with the location information entered by the user and the states of the first indication light associated with each of the areas to match the state of the first indication light and that of the second indication light to provide guidance information for the user. In one embodiment, the conversion table is preloaded in the client wireless device 150 before the user enters the venue.

Each of the location indication devices 120 is configured to emit the first indication light according to the area in which it is installed, and the user identifies the area associated with the location information by whether the first indication light emitted by the location devices 120 match the second indication light emitted by the client wireless device 150, and approaches the area associated with the location information with the guidance of the first indication light and the second indication light.

In each of the areas in the venue installs one of the wireless access points 110, and each wireless access point 110 records location numbers respectively associated with the location indication devices installed in the areas. When the client wireless device 150 is within a scanning region of the wireless access point 110, the wireless access point 110 is configured to receive the location information entered by the user from the client wireless device 150. When any of the location numbers recorded in the wireless access point 110 matches the location information, the client wireless device 150 is configured to display a reminder message (operation S430).

In one embodiment, the reminder message is changing the state of the second indication light, e.g., changing the state from always on to blinking, changing the state from on to off, or changing the color of the second indication light emitted according to the location information. Those who are skilled in the art can use other changes in state, and the present disclosure is not limited hereto.

After the client wireless device 150 is configured to display the reminder message, the user is reminded that he/she is close to the area associated with the location information and controls the client wireless device 150 to transmit a control signal to the wireless access point 110. The wireless access point 110 is coupled to the location indication devices 120 associated with the location numbers recorded on the wireless access point 110, and the state of the first indication light emitted by the location indication device 120 associated with the location information is changed according to the control signal (operation S440). The details of changing the state of the first indication light are given in the accompanying text of FIG. 2, and not repeated herein.

In one embodiment, the client wireless device 150 is configured to display an area floor plan associated with the area included in the location information and label one of the locations associated with the location number included in the location information (operation S450). When there is a large number of locations in the area, the user obtains approximate direction of the location associated with the location information with the area floor plan, and then further locates the precise location by controlling the state of the first indication light emitted by the location indication device 120 associated with the location information, so as to improve the efficiency of seat finding.

In another embodiment, when the scanning region 210A of the wireless access point 110A is too large, the distance between the client wireless device 150 and the wireless access point 110 is used for determining whether the reminder message is displayed or not. The wireless access point 110 is configured to determine distance with signal strength. When the distance between the client wireless device 150 and the wireless access point 110 is smaller than a threshold value, the client wireless device 150 is configured to display the reminder message. The scanning region 210A of the wireless access point 110A is shown in FIG. 2, and a connection region 220A is drawn with the threshold value stored on the wireless access point 110A as the radius and the location of the wireless access point 110A as the center. Moreover, the scanning region 210D and the connection region 220D of the wireless access point 110D are as shown in FIG. 2. When the client wireless device 150 is located as shown in FIG. 2, which in within the connection region 220A, the client wireless device 150 is configured to display the reminder message. Illustratively, the reminder message is not displayed prematurely when the scanning region of the wireless access point 110 is too large and the client wireless device 150 is within the scanning region. Accordingly, the user avoids mistaking the location associated with the location information is close while the distance is still long. Furthermore, the threshold value and the connection region also help to avoid the scenario that the control signal is transmitted but the change in the states is not within observable distance, for the user is still far away from the location associated with the location information.

The intelligent venue entrance guiding method 400 can also be implemented as a computer program or program product stored in a non-transitory computer readable storage medium, e.g., hard disk, soft disk, optical disc or flash memory, and the computer program includes multiple instructions which are executed, such that the processor of a computer or a mobile device performs the intelligent venue entrance guiding method 400.

To sum up, the technical details described in the present disclosure enable users to follow the guidance information provided by the second indication light emitted by the client wireless device and the first indication light emitted by the location indication device to approach the area associated with the location information printed on the ticket, display the reminder message to remind the users to control the location indication device to change the state of the first indication light to locate the correct location associated with the location information on the ticket. Accordingly, the labor needed for managing the venue is reduced greatly, such that the operating cost and human resource are saved. Moreover, the efficiency of finding locations is improved, such that time of the audience is saved and the reviews for the venue become more positive. Last but not least, the wireless access point in the present disclosure can be used to offer better network connectivity to alleviate heavy network load and improve poor network quality caused by huge crowds in a large venue and to provide value-added services to participants of the events.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An intelligent venue entrance guiding system for providing guidance to locations in a venue comprising at least one area, comprising:
a plurality of location indication devices installed in the area and configured for emitting a first indication light according to the area;
at least one wireless access point installed in the area, configured for recording a plurality of location numbers associated with the location indication devices respectively, and coupled to the location indication devices; and
a client wireless device configured for storing a location information and emitting a second indication light according to the location information and displaying a reminder message when the client wireless device is within a scanning region of the wireless access point and the location information is matched with one of the location numbers.

2. The intelligent venue entrance guiding system of claim 1, wherein the reminder message comprises a change in a state of the second indication light.

3. The intelligent venue entrance guiding system of claim 1, wherein the client wireless device is a wearable device.

4. The intelligent venue entrance guiding system of claim 1, wherein the client wireless device comprises:
an area floor plan for labeling one of the locations associated with the location number comprised in the location information.

5. The intelligent venue entrance guiding system of claim 1, wherein the location indication devices comprise one or more LEDs.

6. An intelligent venue entrance guiding method for a client wireless device to provide guidance to locations in a venue comprising at least one area in which a plurality of location indication devices and a wireless access point are installed, comprising:
emitting a first indication light with the location indication devices according to the area;
emitting a second indication light with the client wireless device according to a location information; and
displaying a reminder message when the client wireless device is within a scanning region of the wireless access point in the area, wherein the location information is matched with one of location numbers recorded by the wireless access point, and the location numbers are respectively associated with the location indication devices installed in the area.

7. The intelligent venue entrance guiding method of claim 6, wherein the reminder message comprises a change in a state of the second indication light.

8. The intelligent venue entrance guiding method of claim 6, further comprising:
transmitting a control signal to the wireless access point to change a state of the first indication light of the location indication device associated with said one of the location numbers matched with the location information, wherein the wireless access point is coupled to the location indication devices associated with the location numbers recorded by the wireless access point.

9. The intelligent venue entrance guiding method of claim 6, further comprising:
displaying an area floor plan associated with the area comprised in the location information and labeling one of the locations associated with the location number comprised in the location information.

10. The intelligent venue entrance guiding method of claim 6, further comprising:
displaying the reminder message with the client wireless device when a distance between the client wireless device and the wireless access point is smaller than a threshold value.

11. A client wireless device of providing guidance to locations in a venue comprising at least one area in which a plurality of location indication devices and a wireless access point are installed, the location indication devices respectively emitting a first indication light, and the client wireless device comprising:
a wireless communication unit;
a memory unit configured for storing a location information;
a display unit configured for emitting a second indication light according to the location information; and
a processing unit configured for inducing a reminder message when the wireless communication unit is within a scanning region of the wireless access point and the location information is matched with one of location numbers recorded on the wireless access point, wherein the location numbers are associated with the location indication devices respectively.

12. The client wireless device of claim 11, wherein the reminder message comprises a change in a state of the second indication light.

13. The client wireless device of claim 11, wherein the memory unit is configured for storing an area floor plan associated with the area, the display unit is configured for displaying the area floor plan and labeling one of the locations associated with said one of the location numbers matched with the location information.

14. The client wireless device of claim 11, wherein the wireless communication unit is configured for transmitting a control signal to the wireless access point to change a state of the first indication light of one of the location indication devices associated with one of the location numbers matched with the location information, and the wireless access point is coupled to the location indication devices associated with the location numbers recorded by the wireless access point.

15. The client wireless device of claim 11, wherein the display unit is configured for displaying the reminder message when a distance between the wireless communication unit and the wireless access point is smaller than a threshold value.
